(19) United States
(12) Patent Application Publication
(10) Pub. No.: US 2025/0268374 A1
(43) Pub. Date: Aug. 28, 2025

(54) CABINET ASSEMBLIES AND METHODS OF MAKING THE SAME

(71) Applicant: Cooper Enterprises, Inc., Shelby, OH (US)

(72) Inventor: Gerald Allen Truex, Pataskala, OH (US)

(21) Appl. No.: 18/586,389

(22) Filed: Feb. 23, 2024

(51) Int. Cl. A47B 47/04

(52) U.S. Cl. CPC A47B 47/042; A47B 2220/0052; A47B 2220/008; A47B 2230/0029

(57) ABSTRACT

Devices and systems for and methods of making cabinet assemblies are disclosed that are suitable for wet or humid environments. The cabinet assemblies remain structurally safe and aesthetically pleasing under such conditions, where the cabinet assemblies, when assembled, meet requirements of the Architectural Woodwork Casework American National Standards Institute/Architectural Woodwork Institute (ANSI/AWI) 0641 Duty Level 3.

### FIELD

Technologies disclosed herein relate to devices and systems for and methods of making cabinet assemblies, locker assemblies, shed assemblies, and the like (hereinafter “cabinet assemblies”). More specifically, the technologies described herein relate to cabinet assemblies suitable for use in environments with relatively high humidity or varying humidity, where it is desirable that the cabinet assemblies remain structurally sound (e.g., portions thereof do not warp, bend, bow, rust, and so forth) and, in some cases, aesthetically pleasing, under such conditions. The systems, devices, and methods described herein relate to cabinet assemblies that are impervious to rusting and oxidizing when subject to moisture, as well as resistant to warping, bending, and/or bowing when subject to humidity. This results in the cabinet assemblies remaining aesthetically pleasing and structurally sound, even in humid settings.

### BACKGROUND

Many residential, commercial, and industrial settings require cabinet assemblies in locations that are exposed to humidity and/or other environmental conditions (relatively hot and/or cold temperatures, relatively rapid temperature changes, etc.). Such cabinet assemblies, therefore, are desirably suitable for humid environments, need to remain structurally sound in such environments, and in some situations, may also need to be and remain aesthetically pleasing. In an example, a cabinet assembly placed in a garage of a homeowner or business desirably remains structurally sound as well as aesthetically pleasing over a relatively long period of time (e.g., multiple years); accordingly, such cabinet assembly is desirably resistant to rust and oxidation and resistant to warping, bending, and/or bowing when subject relatively high humidity. Cabinet assemblies that are designed for use in garages are conventionally formed of metal, such as steel. These cabinets tend to be relatively expensive and often rust over time. Other cabinet assemblies marketed for use in garages are formed of a composite wood; these conventional cabinet assemblies are significantly less expensive than metal cabinet assemblies. Existing cabinet assemblies formed of composite wood, however, tend to warp when subjected to humidity and/or temperature change.

Furthermore, some materials used to make conventional cabinet assemblies are not able to be painted or laminated with an additional layer of material without appearing bumpy or having uneven surfaces, which for some applications may be undesirable.

Thus, there remains an unmet need for cabinet assemblies that are resistant to rust and oxidation, that are also resistant to warping, bending, and/or bowing when subject to humidity (or intermittent moisture, such as rain), that remain structurally sound and aesthetically pleasing, and that are relatively inexpensive in comparison to conventional metal cabinetry.

Furthermore, some materials used to make conventional cabinet assemblies are not able to be painted or laminated with an additional layer of material without appearing bumpy or having uneven surfaces, which for some applications may be undesirable.

### SUMMARY

The following is a brief summary of subject matter that is described in greater detail herein. This summary is not intended to be limiting as to the scope of the claims.

Described herein are various technologies pertaining to cabinet assemblies that are well-suited for use in environments that are subjected to humidity and/or temperature change. Specifically, the technologies described herein exhibit many advantages over conventional cabinet assemblies, including being impervious to rust as well as being highly resistant to warping, bending, and/or bowing when subject to intermittent moisture or humidity. Further, the cabinet assemblies described herein remain structurally sound and aesthetically pleasing in environments that have relatively high humidity and are subject to temperature change. Furthermore, the cabinet assemblies described herein can be sanded, painted (stained), and/or laminated for aesthetic purposes; however, sanding, painting (staining), and/or laminating casework of the cabinet assemblies is optional. The cabinet assemblies of the present disclosure can also be assembled by the end user using minimal tools due to the cabinet assemblies having features that allow for attachment of casework of the cabinet assemblies through use of dowel-clip assemblies, as will be described further herein.

In some exemplary embodiments, a cabinet assembly is disclosed herein, where the cabinet assembly includes a side panel and a top panel that is orthogonal to the side panel. The side panel is fixedly attached to the top panel, where the side panel and the top panel are composed of a composite material. The composite material is composed of strand-based wood sheets and a suitable binder. The cabinet assembly, when constructed, is compliant with American National Standards Institute/Architectural Woodwork Institute (ANSI/AWI) Architectural Woodwork Casework 0641 Duty Level 3.

In further exemplary embodiments, a method for constructing a cabinet assembly includes obtaining a side panel and a top panel. The method also includes fixedly attaching the side panel to the top panel, where the side panel is orthogonal to the top panel. The side panel and the top panel are composed of strand-based wood sheets with a suitable binder. The cabinet assembly, when constructed, meets requirements of ANSI/AWI Architectural Woodwork Casework 0641 Duty Level 3.

In still further exemplary embodiments, a panel system for a cabinet assembly includes a side panel and a top panel that is orthogonal to the side panel. The side panel is coupled to the top panel, and both the side panel and the top panel are composed of a composite material. The composite material is composed of strand-based wood sheets and a suitable binder. The cabinet assembly, when constructed, is in compliance with ANSI/AWI Architectural Woodwork Casework 0641 Duty Level 3.

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

The general inventive concepts, as well as embodiments and advantages thereof, are described below in greater detail, by way of example, with reference to the drawings in which:

FIG. 1 is a perspective view of an exemplary cabinet assembly;

FIG. 2 is a perspective view of a cabinet assembly bottom panel and clips, the clips being a portion of a dowel-clip arrangement;

FIG. 3 is a perspective view of a cabinet assembly back panel and dowel devices, the dowel-devices being a portion of a dowel-clip arrangement;

FIG. 4 is a flow diagram illustrating a method for forming casework of a cabinet assembly; and

FIG. 5 is a flow diagram illustrating a method for assembling a cabinet assembly.

### DETAILED DESCRIPTION

Unless defined otherwise, all technical and scientific terms used herein have the same meanings as commonly understood by one of ordinary skill in the art to which this invention belongs. The term “about,” as used herein to modify any numerical values, encompasses the specific numerical value(s) without any modification, as well as reasonable deviations that still achieve the particular purpose associated with the values.

All references, publications, patents, patent applications, and commercial materials mentioned herein are incorporated herein by reference for all purposes including for describing and disclosing the technologies which are reported in the publications which might be used in connection with the invention. Nothing herein is to be construed as an admission that the invention is not entitled to antedate such disclosure by virtue of prior invention.

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

Described herein are technologies related to cabinet assemblies that are impervious to rust and oxidation when subjected to moisture or humidity over a relatively long period of time (e.g., years), as well as highly resistant to warping, bending, and/or bowing when subject to intermittent moisture or humidity (and temperature changes) over the relatively long period of time. The cabinet assemblies therefore remain structurally sound and aesthetically pleasing under such conditions. Furthermore, the cabinet assemblies described herein can be sanded and/or painted and/or laminated, though they do not require sanding, paint, or lamination to achieve the aforementioned properties.

The material used to construct at least some portions of the cabinet assemblies disclosed herein (such as casework of the cabinet assemblies) is a composite material of strand-based wood sheets and a suitable binder. It is contemplated that some components of the cabinet assemblies may comprise other suitable materials without affecting the performance of the cabinet assemblies. The material allows the cabinet assemblies constructed therefrom to be impervious to rust and oxidation, as well as highly resistant to warping, bending, and/or bowing, when subject to moisture, humidity, and/or temperature change over a relatively long period of time. The cabinet assemblies described herein meet requirements for American National Standards Institute/Architectural Woodwork Institute (ANSI/AWI) Architectural Woodwork Casework 0641 Duty Level 3. More specifically, the cabinet assembly, when formed of the material described herein and constructed according to the method described herein, meet requirements for ANSI/AWI Architectural Woodwork Casework 0641 Duty Level 3.

Furthermore, in an example, the material has a bending stiffness (“EI”) in the parallel direction (nominal 8′) of about 395,120 lbf-in²/ft and in the perpendicular direction (nominal 4′) of about 160,980 lbf-in²/ft.

In another example, the material has a bending strength in the parallel direction (nominal 8′) of about 1,300 F_{b}S ((lb-in/ft of width)) and a bending strength in the perpendicular direction (nominal 4′) of about 750 F_{b}S ((lb-in/ft of width)).

In some embodiments, the binder included in the material is an adhesive having a moisture resistance of at least 150 PSI (ASTM D3498). In another example, the binder is an adhesive having a moisture resistance of at least 163 PSI (ASTM D3498). Further, in some embodiments, the cabinet assemblies or parts thereof may be coated with a laminate or other sealant which may further increase moisture resistance.

In some embodiments, the material is sanded. In an example, each face of each panel used to construct a cabinet assembly is sanded 0.020 inches. The material is also readily paintable, such as with transparent paint or with any color scheme including patterns. For example, a cabinet assembly formed of the material can be painted with a camouflage scheme to blend into the surrounding environment for outdoor activities such as hunting. The cabinet assemblies can also be laminated with a protective coating and/or a decorative coating. Thus, cabinet assemblies at least partially formed of the material described above can be sanded, and/or painted, and/or laminated.

In some embodiments, a cabinet assembly described herein is provided to the end user in multiple parts. The cabinet assembly can be finally assembled by the end user, where minimal tools are required by the end user to assemble the cabinet assembly. For example, in some embodiments, only a mallet (e.g., a rubber mallet) is necessary to assemble the cabinet assembly, as a result of the dowel-clip arrangement, which is described further below.

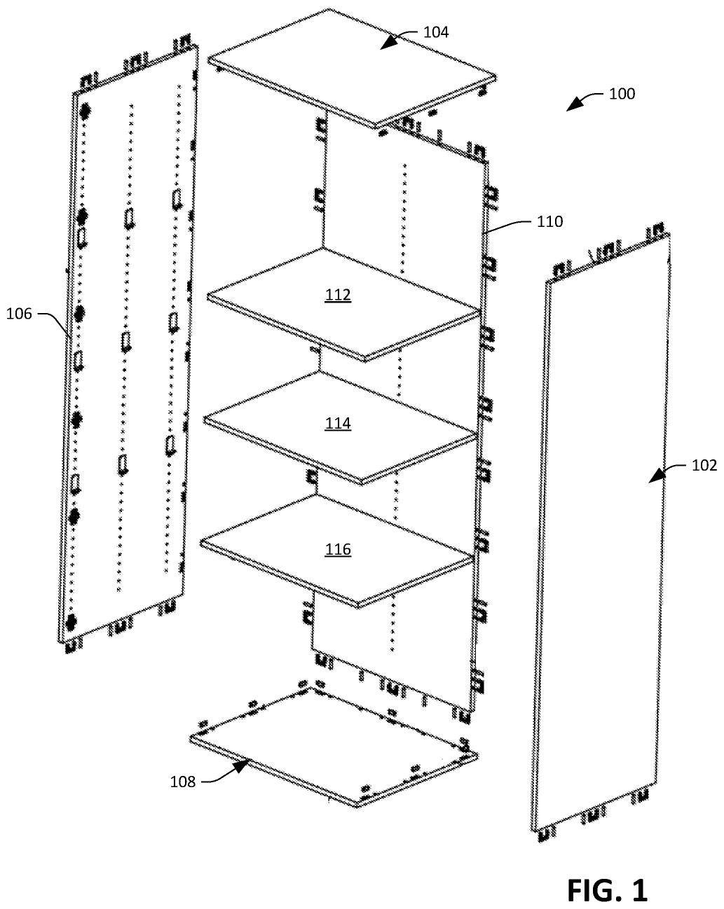

FIG. 1 illustrates an exploded view of a cabinet assembly 100. The cabinet assembly 100 shown in FIG. 1 comprises a side panel 102 and a top panel 104, where the top panel 104 is orthogonal to the side panel 102, and the side panel 102 is fixedly attached to the top panel 104. The top panel 104 and the side panel 102 are composed of the material described above, and thus have the properties defined above (e.g., moisture resistance, bending stiffness, and bending strength). Optionally, the top panel 104 is fixedly attached to the side panel 102 via dowel-clip arrangements, described in greater detail below (not shown).

In the cabinet assembly 100, the top panel 104 is fixedly attached to a second side panel 106, where the second side panel 106 is parallel to the side panel 102 and orthogonal to the top panel 104. The cabinet assembly 100 further includes a bottom panel 108 that is parallel to the top panel 104 and orthogonal to the side panels 102 and 106. Further, the cabinet assembly 100 includes a back panel 110 that extends vertically from the bottom panel 108 to the top panel 104 when the cabinet assembly 100 is assembled, where the back panel 110 is orthogonal to the bottom panel 108, the top panel 104, the first side panel 102, and the second side panel 106. The panels 102-110 at least partially form an outer shell of the cabinet assembly 100. In an example, the panels 102-110 are coupled to one another by way of dowel-clip arrangements. Alternatively, at least one of the panels 102-110 can be coupled to another one of the panels 102-110 by way of other suitable attachment technologies (dowel rods, brackets, cam locks, etc.). At least one of the panels 102-110 is formed of the material described above (i.e., an oriented strand board (OSB) material that is American Plywood Association (APA)-verified for exceptional thickness and strength). In an example, the material can be designed for use as subflooring, and thus is manufactured to be resistant to moisture.

In further embodiments, the cabinet assembly 100 includes inner side panels (not shown), which are each orthogonal to the top panel 104. The inner side panels are not part of outer shell of the cabinet assembly 100. In some embodiments, the caseworks of the outer shell of the cabinet assembly 100 are composed of the material and are coupled together by way of the dowel-clip arrangements. Caseworks of the interior of the cabinet assembly can optionally be coupled to the side panels 102 and 106 and/or the top panel 104 by way of some other suitable coupling technologies. The inner side panels may be coupled to the top panel 104 and/or bottom panel 108. The cabinet assembly 100 may include any number of inner side panels. In some embodiments, all of the inner side panels are fixedly attached to top panel 104 and/or bottom panel 108 via dowel-clip arrangements. In other embodiments, some or all of the inner side panels are fixedly attached to top panel 104 and/or bottom panel 108 using other suitable technologies, such as cam locks.

Additionally, the cabinet assembly 100 may include any number of shelves 112-116. In some embodiments, the shelves 112-116 are parallel to the top panel 104 and orthogonal to the side panel 102 (and orthogonal to any inner side panels present and orthogonal to the second side panel 106). In some embodiments, the shelves 112-116 may be coupled to the side panel 102 and the second side panel 106. In other embodiments, the shelves may be coupled to multiple inner side panels. In still other embodiments, the shelves may be coupled to the first side panel 102 and an inner side panel, or to the second side panel 106 and an inner side panel. In some embodiments, all of the shelves 112-116 are fixedly attached via the dowel-clip arrangements. In other embodiments, some of the shelves 112-116 are fixedly attached via the dowel-clip arrangements. Alternatively, all of the shelves 112-116 may be coupled using other means such as brackets, dowel rods and corresponding apertures, cam locks, etc. In some embodiments, all of the inner side panels and shelves 112-116 are composed of the material. In other embodiments, some of the inner side panels and/or shelves 112-116 are composed of the material. In further embodiments, all of the inner side panels and shelves 112-116 are not composed of the material but rather are composed of another suitable material (such as metal or an OSB that differs from the OSB of the material used to form the panels 102-108).

In one embodiment, all caseworks of the cabinet assembly are coupled together using the dowel-clip arrangements. In another embodiment, the caseworks comprising the outer shell of the cabinet assembly (the panels 102-108) are coupled using the dowel-clip arrangement and all other caseworks of the cabinet assembly 100 are coupled using other suitable coupling technologies. In another embodiment, the top panel 104 and the first side panel 102 are coupled together using dowel-clip arrangements and all other caseworks of the cabinet assembly are coupled using other suitable coupling technologies.

The cabinet assembly 100 may be fastened to a wall or may be free standing. The cabinet assembly 100 may include any configuration of inner side panels, as well as any configuration of doors, drawers, shelves, hanging rods, rails, etc. (which may be composed of the material in some embodiments).

In some embodiments, some or all of the caseworks of the cabinet assembly 100 are sanded. In yet further embodiments, some or all of the caseworks of the cabinet assembly are also painted with a suitable color scheme, including patterns. For example, at least a portion of an exterior of the cabinet assembly 100 can be painted with a camouflage scheme, thereby causing the cabinet to blend into a surrounding outdoor environment for activities such as hunting or fishing. When the cabinet assembly 100 is sufficiently large, then, such assembly 100 can be used as a hunting blind; as the cabinet assembly 100 is formed of the material discussed above, the cabinet assembly 100 can remain outdoors and be subjected to outdoor elements over a relatively long period of time without bowing, bending, etc. Additionally, in some embodiments, some or all of the caseworks of the cabinet assembly are also laminated such as with a coating that increases moisture resistance or a decorative coating.

In an example, at least one of the panels of the cabinet assembly 100 can be stained with a waterbase stain to provide a base for adhesion to the panel. The stain can be dried with heated forced air, whereupon multiple applications of 100% solids UV filler, sanding sealer, and topcoat can be undertaken with respect to the panel. The UV filler is used to provide a smooth, totally grain pore-filled surface. In an example, one to two coats of UV filler are used, depending on the desired appearance. The UV filler is B-stage cured to allow for adhesion of the next coating application. In applications with a grain pore look is desired, the UV filler is unnecessary.

Further, optionally, an abrasion-resistant sealer can be used to build wear resistance on the panels; for instance, one to two applications of an aluminum oxide sealer film can add commercial-quality wear resistance to the panels. The abrasion resistant coating applications can be B-stage cured for adhesion prior to application of a sanding sealer. The sanding sealer can be used to build film thickness level the coating surface prior to a final topcoat application being applied to form a smooth surface. Multiple sanding sealer applications can be B-stage cured for adhesion prior to application of a final sanding sealer, where the final sanding sealer is fully cured to allow sanding for leveling the coating film and again providing adhesion of the topcoat applications.

An application of 100% solids UV topcoat can then be placed on the panels to provide a smooth, scratch and wear resistant film. Resins systems used for the filler, sanding sealer, and topcoat, along with ceramic mineral technology incorporated into the coatings, provide for stain and chemical resistance, adhesion, cold check cycles, taber abrasion and coefficient of friction numbers at a film thickness of a little over two millimeters.

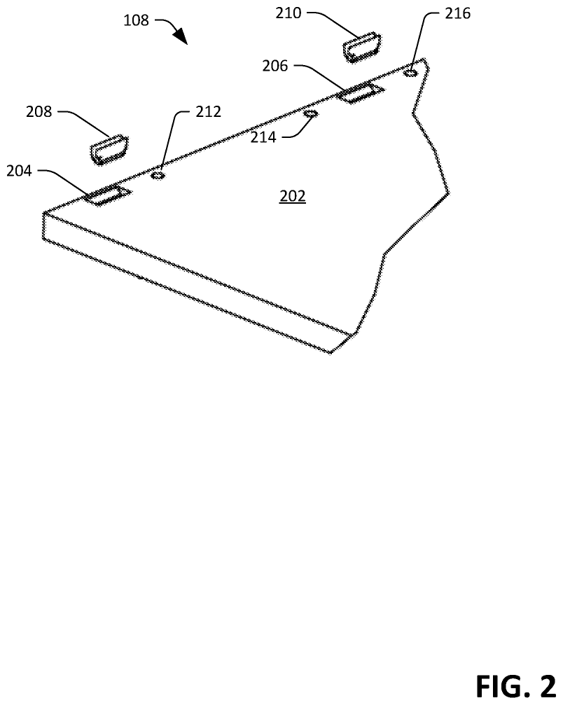

FIG. 2 is a perspective view of a portion of the bottom panel 108 where the second side panel 106 is coupled to the bottom panel 108, where FIG. 2 illustrates insertion of dowel clips into recesses formed in the bottom panel 108 in connection with coupling the bottom panel 108 to the second side panel 106. As illustrated in FIG. 2, the bottom panel 108 includes an upper side 202 that defines a portion of an interior of the cabinet assembly 100; the cabinet assembly 100 also includes an exterior side (not shown) that is parallel to the interior side 202 and forms at least a portion of the exterior of the cabinet assembly 100.

The interior side 202 of the bottom panel 108 includes dowel clip recesses 204-206 that are configured to receive dowel clips 3208-210, respectively. The recesses 204-206 extend into the bottom panel 108 orthogonally away from the interior side 202 of the bottom panel 108. At least one sidewall of each of the recesses 204-206 includes a respective notch. The dowel clips 208-210 include an extension (or multiple extensions) that correspond to the notches in the sidewalls of the recesses 204-206. Moreover, the dowel clips 208-210 exhibit spring force when compressed. The dowel clips 208-210 are inserted into the recesses 204-206, respectively; for example, a rubber mallet can be employed to provide sufficient force to insert the dowel clips 208-210 into the respective recesses 204-206. The extensions of the dowel clips 208-210 populate the notches in the sidewalls of the recesses 204-206, thereby permanently fixing the dowel clips 208-210 to the bottom panel 108. The interior side 202 of the bottom panel 108 also optionally includes dowel recesses 212-216, where the dowel recesses 212-216 are configured to receive dowel rods and facilitate aligning, for example, the second side panel 106 with the bottom panel 108. For instance, the second side panel 106 has corresponding dowel recesses that align with the dowel recesses 212-216 when the bottom panel 108 and the second side panel 106 are coupled to one another.

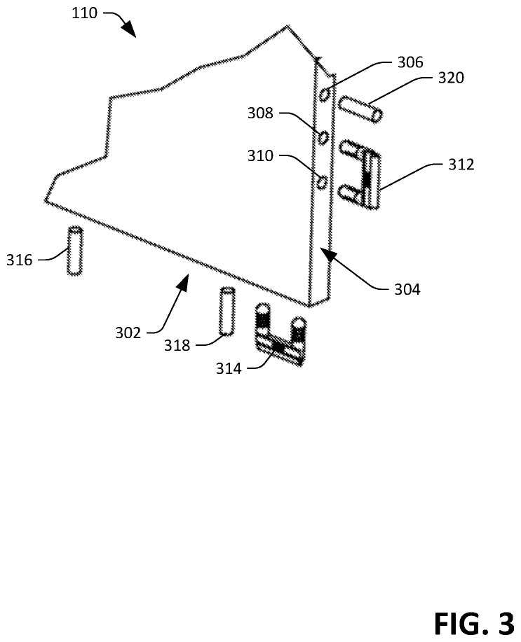

FIG. 3 depicts a perspective view of a portion of the back panel 110 of the cabinet assembly 100, where FIG. 3 is set forth to illustrate an approach for permanently securing the back panel 110 to the bottom panel 108. The back panel 110 includes a first side 302 that is to be flush with the interior side 202 of the bottom panel 108 when the cabinet assembly 100 is assembled. The first side 302 includes recesses (not shown) that extend into the back panel 110. The back panel 110 also includes a second side 304 that, when the cabinet assembly 100 is assembled, is flush with the interior of the first side panel 102. The second side 304 includes recesses 306-310 that extend into the back panel 110; in the example shown in FIG. 3, the recesses 306-310 have a circular cross section, although other shapes are contemplated. A pair of recesses in the recesses 306-310 is configured to receive a corresponding pair of ridged protrusions of a first dowel device 312. Thus, FIG. 3 depicts the first dowel device 312 being fixed to the back panel 110 through insertion of two ridged protrusions into the recesses 308-310, while a second dowel device 314 is fixed to the back panel 110 through insertion of two ridged protrusions into corresponding recesses on the first side 302 of the back panel 110. The ridges of the protrusions of the dowel devices 312 and 314 act to permanently secure the dowel devices 312 and 314 to the back panel 110. Upon the dowel devices 312 and 314 being secured to the back panel 110, extensions of the dowel devices 312 and 314 with an arrow-shaped cross section extend away from the second side 304 and the first side 302, respectively, of the back panel 110. Dowel rods 316 and 318 are insertable into corresponding recesses in the first side 302 of the back panel 110; similarly, a dowl rod 320 is insertable into the recess 306 in the second side 304 of the back panel 110. The dowl rods 316 and 318 are also insertable into corresponding recesses of the bottom panel 108 (ensuring proper alignment between the back panel 110 and the bottom panel 108 when the back panel 110 and the bottom panel 108 are coupled to one another), and the dowl rod 320 is insertable into a corresponding recess of the first side panel 102 (ensuring proper alignment between the back panel 110 and the first side panel 102 when the back panel 110 and the first side panel 102 are coupled to one another).

As mentioned above, the dowel-clip arrangement allows the cabinet assemblies described herein to be finally assembled by the end user using minimal tools. For example, in some embodiments, the end user can finally assemble the cabinet assembly using only a mallet (e.g., a rubber mallet) to apply sufficient force to cause the extensions of the dowel devices 312 and 314 to be secured in corresponding dowel clips of other panels. More specifically, the interiors of the dowel clips have ridges that correspond to the arrow-shaped cross section of the dowel devices 312 and 314, such that when the protrusions of the dowel devices 312 and 314 are inserted into the corresponding dowel clips, the ridges of the dowel clips become flush with the backside of the arrow-shaped protrusions, thus permanently joining the dowel devices 312 and 314 with the dowel. No screwdriver, drill, etc. is necessary. Moreover, cam lock faces are not exposed anywhere on the exterior of the panels 102-110, thereby providing improved aesthetics over conventional cabinet assemblies.

As indicated previously, the cabinet assembly 100 can be a garage cabinet assembly. In other examples, the cabinet assembly 100 is or is included in a closet assembly, in an outdoor kitchen assembly, in a hunting blind, in a hunting cabinet, etc.

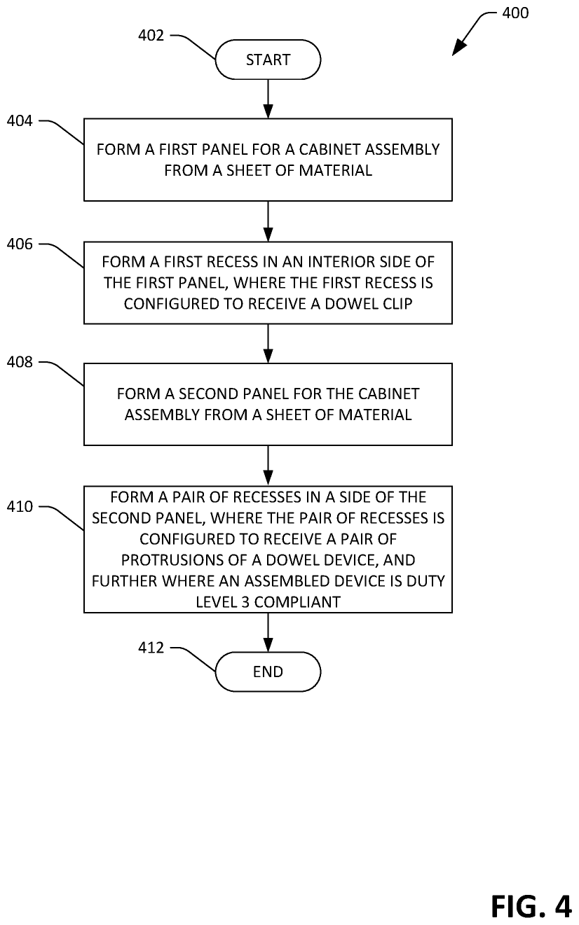

Now referring to FIG. 4, a method 400 for manufacturing componentry of a cabinet assembly is illustrated. The method 400 starts at 402, and at 404 a first panel for a cabinet assembly is formed from a sheet of material. Optionally, at 406, a first recess is formed in an interior side of the first panel, where the first recess is configured to receive a dowel clip. Moreover, a second recess is optionally formed in the interior side of the first panel, where the second recess is configured to receive a dowel rod (for purposes of alignment).

At 408, a second panel of the cabinet assembly is formed from a sheet of material (which may be the same sheet of material or a different sheet of material used to form the first panel). Optionally, at 410, a pair of recesses is formed in a side of the second panel, where the pair of recesses is configured to receive a pair of corresponding protrusions of a dowel device. Moreover, a third recess is optionally formed in the side of the second panel, where the third recess is configured to receive the dowel rod (to assist with aligning the first panel and the second panel when the two panels are coupled). The cabinet assembly, once constructed, meets the requirements of ANSI/AWI Architectural Woodwork Casework 0641 Duty Level 3. The method 400 completes at 412.

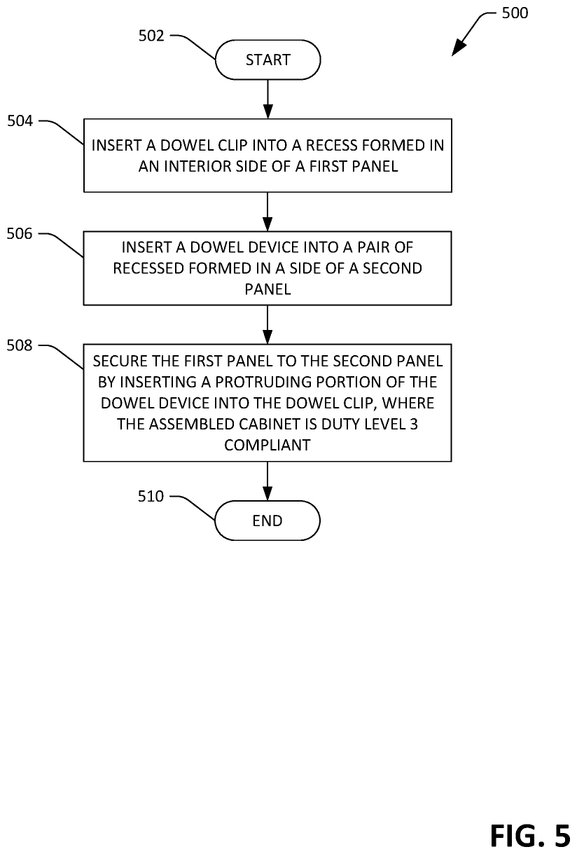

Turning to FIG. 5, a method 500 for assembling a cabinet assembly is depicted. The method 500 starts at 502, and at 504, a dowel clip is inserted into a recess formed in an interior side of a first panel. The first panel is formed of the material described above. At 506, a dowel device is inserted into a pair of recesses formed in a side of a second panel, where the second panel is also formed of the material referenced above. More specifically, a pair of protrusions of the dowel device is inserted into the pair of recesses formed in the side of the second panel. At 508, the first panel is secured to the second panel by inserting a protruding portion of the dowel device into the dowel clip. For example, a rubber mallet can be used to apply force on an exterior side of the first panel to force the protruding portion of the dowel device to be inserted into the dowel clip. The cabinet assembly, once constructed in accordance with the method 500, meets the requirements of ANSI/AWI Architectural Woodwork Casework 0641 Duty Level 3. The method 500 completes at 510.

It may be possible to utilize the various inventive concepts described herein in combination with one another. Additionally, any particular element recited as relating to a particularly disclosed embodiment should be interpreted as available for use with all disclosed embodiments, unless incorporation of the particular element would be contradictory to the express terms of the embodiment. The scope of the general inventive concepts presented herein are not intended to be limited to the particular exemplary embodiments shown and described herein. From the disclosure given, those skilled in the art will not only understand the general inventive concepts and their attendant advantages but will also find apparent various changes and modifications thereto. For example, the cabinet assemblies described herein can include features and structures such as drawers, hanging rods, doors, etc. in any orientation and arrangement. It is sought, therefore, to cover all such changes and modifications as fall within the spirit and scope of the general inventive concepts, as described and/or claimed herein, and any equivalents thereof.

What is claimed is:

1. A cabinet assembly comprising:
a side panel; and
a top panel orthogonal to the side panel;
wherein the side panel is fixedly attached to the top panel;
wherein the side panel and the top panel are composed of a composite material;
wherein the composite material is composed of strand-based wood sheets and a suitable binder; and
wherein the cabinet assembly, when constructed, is compliant with American National Standards Institute/Architectural Woodwork Institute (ANSI/AWI) Architectural Woodwork Casework 0641 Duty Level 3.

2. The cabinet assembly of claim 1, wherein the side panel is fixedly attached to the top panel by a dowel-clip arrangement, where the side panel has a first side and a second side, where the first side of the side panel has a recessed region, where a clip having a notch is inserted into the recessed region, and where the top panel has a void, where a dowel device having a ridge is inserted into the void of the top panel, and further where the ridge of the dowel device of the top panel fits inside the notch of the clip in the recessed region of the side panel, such that the side panel is fixedly attached to the top panel.

3. The cabinet assembly of claim 1, wherein at least one face of each of the side panel and the top panel are sanded to remove approximately 0.02 inches of the at least one face of each of the side panel and the top panel.

4. The cabinet assembly of claim 1, wherein the side panel and the top panel are painted, laminated, or both painted and laminated.

5. The cabinet assembly of claim 1, further comprising a shelf and a second side panel, wherein the second side panel is orthogonal and fixedly attached to the top panel and the shelf is orthogonal to the side panel and the second side panel, and where the shelf is fixedly attached to the side panel and to the second side panel.

6. The cabinet assembly of claim 1, wherein the composite material has a moisture resistance of 163 PSI according to American Society for Testing and Materials (ASTM) D3498.

7. The cabinet assembly of claim 1, wherein the composite material has a bending stiffness (“EI”) in the parallel direction (nominal 8′) of about 395,120 lbf-in²/ft and in the perpendicular direction (nominal 4′) of about 160,980 lbf-in²/ft.

8. A method for constructing a cabinet assembly comprising:
obtaining a side panel and a top panel;
fixedly attaching the side panel to the top panel;
wherein the side panel is orthogonal to the top panel;
wherein the side panel and the top panel are composed of strand-based wood sheets with a suitable binder; and
wherein the cabinet assembly, when constructed, meets requirements of American National Standards Institute/Architectural Woodwork Institute (ANSI/AWI) Architectural Woodwork Casework 0641 Duty Level 3.

9. The method of claim 8, wherein the side panel is fixedly attached to the top panel by a dowel-clip arrangement, where the side panel has a first side and a second side, where the first side of the side panel has a recessed region, where a clip having a notch is inserted into the recessed region, and where the top panel has a void, where a dowel device having a ridge is inserted into the void of the top panel, and further where the ridge of the dowel device of the top panel fits inside the notch of the clip in the recessed region of the side panel, such that the side panel is fixedly attached to the top panel.

10. The method of claim 8, wherein the side panel and the top panel are sanded.

11. The method of claim 8, wherein the side panel and the top panel are painted, laminated, or both painted and laminated.

12. The method of claim 8, further comprising fixedly attaching a second side panel to the top panel, and fixedly attaching a shelf to the second side panel and to the side panel, where the shelf and the second side panel are both composed of strand-based wood sheets with a suitable binder, where the shelf and the second side panel are both in conformance with the American National Standards Institute/Architectural Woodwork Institute (ANSI/AWI) Architectural Woodwork Casework 0641 Duty Level 3 construction standard, where the second side panel is orthogonal to the top panel and where the shelf is orthogonal to the side panel and to the second side panel, where the second side panel and shelf are sanded, and where the second side panel and shelf are painted, laminated, or both painted and laminated.

13. The method of claim 8, wherein the strand-based wood sheets with a suitable binder have a moisture resistance of 163 PSI according to American Society for Testing and Materials (ASTM) D3498.

14. A panel system for use in a cabinet assembly comprising:
a side panel; and
a top panel orthogonal to the side panel;
wherein the side panel is coupled to the top panel;
wherein the side panel and the top panel are composed of a composite material;
wherein the composite material is composed of strand-based wood sheets and a suitable binder; and
wherein the cabinet assembly, when constructed, is in compliance with American National Standards Institute/Architectural Woodwork Institute (ANSI/AWI) Architectural Woodwork Casework 0641 Duty Level 3.

15. The panel system of claim 14, wherein the side panel is fixedly attached to the top panel by a dowel-clip arrangement, where the side panel has a first side and a second side, where the first side of the side panel has a recessed region, where a clip having a notch is inserted into the recessed region, and where the top panel has a void, where a dowel device having a ridge is inserted into the void of the top panel, and further where the ridge of the dowel device of the top panel fits inside the notch of the clip in the recessed region of the side panel, such that the side panel is fixedly attached to the top panel.

16. The panel system of claim 14, wherein the side panel and the top panel are sanded.

17. The panel system of claim 14, wherein the side panel and the top panel are painted, laminated, or both painted and laminated.

18. The panel system of claim 14, wherein the composite material has a bending strength in the parallel direction (nominal 8′) of about 1,300 F_{b}S ((lb-in/ft of width)) and a bending strength in the perpendicular direction (nominal 4′) of about 750 F_{b}S ((lb-in/ft of width)).

19. The panel system of claim 14, wherein the composite material has a bending stiffness (“EI”) in the parallel direction (nominal 8′) of about 395,120 lbf-in²/ft and in the perpendicular direction (nominal 4′) of about 160,980 lbf-in²/ft.

20. The panel system of claim 14, wherein the side panel and the top panel can be assembled via a dowel-clip arrangement using a rubber mallet.
